(19) United States
(12) Patent Application Publication
(10) Pub. No.: US 2010/0194648 A1
(43) Pub. Date: Aug. 5, 2010

(54) BUILT-IN ANTENNA FOR PORTABLE WIRELESS TERMINAL

(75) Inventors: Sang-Ha LEE, Gyeonggi-do (KR); Jung-Ho PARK, Gyeonggi-do (KR); Dong-Hwan KIM, Gyeonggi-do (KR); Yong-Jin KIM, Seoul (KR); Jae-Ho LEE, Gyeonggi-do (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/696,242

(22) Filed: Jan. 29, 2010

(30) Foreign Application Priority Data
Jan. 30, 2009 (KR) 10-2009-0007436

(51) Int. Cl. H01Q 1/38; H01Q 1/24

(52) U.S. Cl. 343/702; 343/700 MS

(57) ABSTRACT

A built-in antenna of a portable wireless terminal is provided. The antenna includes a first antenna radiator, a carrier, and at least one second antenna radiator. The first antenna radiator transmits/receives a signal. The first antenna radiator is attached to a carrier. The at least one second antenna radiator is detachable from the carrier and is electrically connected with the first antenna radiator when coupled to the carrier to update a resonance frequency in cooperation with the first antenna radiator.

### CLAIM OF PRIORITY

This application claims the benefit of the earlier filling date, under 35 U.S.C. §119, from patent application Ser. No. 10-2009-0007436 filed in the Korean Intellectual Property Office on Jan. 30, 2009, the contents of which are incorporated by reference in its entirety, herein.

### BACKGROUND OF THE INVENTION

1. Field of Invention

The present invention relates to a built-in antenna of a portable wireless terminal. More particularly, the present invention relates to a built-in antenna of a portable wireless terminal that can selectively change a resonance frequency.

2. Description of the Related Art

In response to technological advances of the electronic communication industry, portable wireless terminals are being miniaturized in a lightweight slim profile and diversified in their functions. For example, in such terminals, a speaker unit for producing melodies of various chords, and/or a color display unit with millions of pixels is arranged in some of the new portable devices. In addition to a phone call function, the portable wireless terminals now typically provide a music listening function through a Motion Picture Expert Group Audio Layer-3 (MP3) Player(MP3P). Furthermore, through the color display unit, the portable wireless terminal provides functions for receiving not only various game content but also radio broadcasting and Digital Multimedia Broadcasting (DMB) content.

Generally, a portable wireless terminal primarily uses a built-in antenna that allows the terminal to be made light and slim. However, if it is desired to provide the portable wireless terminal with greater radio wave transmission/reception, the built-in antenna is designed to be large so as to have high directivity. Therefore, in a circumstance where a separation distance between parts has been reduced to accommodate a lightweight slim profile, it is difficult to secure the space necessary for a larger antenna and improve the transmission/reception performance of the terminal. Furthermore, a portable wireless terminal that can process various frequency bands is desired, and therefore, a built-in antenna that can selectively process a signal in a different frequency bands is needed.

### SUMMARY OF THE INVENTION

The present invention is to provide an antenna for a portable wireless terminal for improving radiation performance by securing an antenna space without increasing a volume of the portable wireless terminal.

An exemplary aspect of the present invention is to provide an antenna for a portable wireless terminal that can transmit/receive a signal by selectively controlling a resonance frequency band.

In accordance with an exemplary aspect of the present invention, a built-in antenna of a portable wireless terminal is provided. The antenna includes a first antenna radiator for transceiving a signal, a carrier for fixing the first antenna radiator thereon, and at least one second antenna radiator detachable from the carrier, for being electrically connected with the first antenna radiator when coupled to the carrier to update a resonance frequency in cooperation with the first antenna radiator.

In accordance with another exemplary aspect of the present invention, a portable wireless terminal including a built-in antenna is provided. The antenna includes a first antenna radiator for transceiving a signal, a carrier for fixing the first antenna radiator thereon and at least one second antenna radiator detachable from the carrier, for being electrically connected with the first antenna radiator when coupled to the carrier to update a resonance frequency in cooperation with the first antenna radiator.

Other exemplary aspects, advantages and salient features of the invention will become more apparent to those skilled in the art from the following detailed description, which, taken in conjunction with the annexed drawings, discloses exemplary embodiments of the invention in more detail.

### BRIEF DESCRIPTION OF THE DRAWINGS

The above features and advantages of certain exemplary embodiments of the present invention will be more apparent from the following detail description when taken in conjunction with the accompanying drawings, in which:

FIG. 1 is a perspective view illustrating a portable wireless terminal according to an exemplary embodiment of the present invention;

FIG. 2 is a perspective view illustrating a built-in antenna according to an exemplary embodiment of the present invention;

FIG. 3 is an exploded perspective view illustrating a matching pad separated from a built-in antenna according to an exemplary embodiment of the present invention;

FIG. 4 is an exploded perspective view illustrating a matching pad coupled in a built-in antenna according to an exemplary embodiment of the present invention;

FIG. 5 is a perspective view illustrating a built-in antenna according to an exemplary embodiment of the present invention; and

FIG. 6 is a perspective view illustrating a built-in antenna according to another exemplary embodiment of the present invention.

Throughout the drawings, like reference numerals will be understood to refer to like parts, components and structures.

### DETAILED DESCRIPTION OF THE INVENTION

The following description, with reference to the accompanying drawings, is provided to assist a person of ordinary skill in the art with a comprehensive understanding of exemplary embodiments of the invention. The description includes various specific details to assist in that understanding but these details are to be regarded as merely exemplary. Accordingly, those of ordinary skill in the art will recognize that various changes and modifications of the embodiments described herein can be made without departing from the scope and spirit of the invention. Also, descriptions of well-known functions and constructions may be omitted for clarity and conciseness so as not to obscure appreciation of the present invention by a person of ordinary skill with such well-known functions and constructions.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims.

It is to be understood that the singular forms “a”, “an”, and “the” include plural references unless the context clearly dictates otherwise. Thus, for example, reference to “a component surface” typically includes reference to one or more of such surfaces.

By the term “substantially” typically means that the recited characteristic, parameter, or value need not be achieved exactly, but that deviations or variations, including for example, tolerances, measurement error, measurement accuracy limitations and other factors known to those skilled in the art, and may occur in amounts that do not preclude the effect the characteristic was intended to provide.

Preferred embodiments of the present invention will be described below with reference to the accompanying drawings.

Exemplary embodiments of the present invention provide a built-in antenna of a portable wireless terminal. More particularly, the present invention provides a built-in antenna that can transmit and receive a signal by selectively controlling a resonance frequency band.

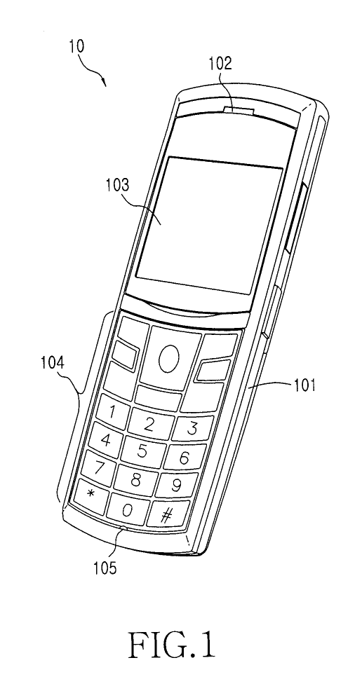

In description of the present invention, the construction of the present invention is applied to a bar type portable wireless terminal as illustrated in FIG. 1. The present invention, however, is not limited thereto but may be applicable to other portable wireless terminals such as a folder type terminal, a slide type terminal, and the like without departing from the spirit of the present invention.

FIG. 1 is a perspective view illustrating a portable wireless terminal according to an exemplary embodiment of the present invention.

Referring now to FIG. 1, the portable wireless terminal 10 includes a case frame 101 that defines an outer surface, and elements installed in an inner space of the case frame 101. The portable wireless terminal 10 includes the elements of a speaker 102 for outputting a voice signal and a display 103 for outputting a video signal. The portable wireless terminal 100 also includes a keypad assembly 104, which is a data input means and a microphone 105 for inputting a voice signal. The display 103 may be a Liquid Crystal Display (LCD) having millions of pixels. In a case where a touchscreen function is provided to the LCD, the display 103 may function as the data input unit in place of the keypad assembly 103 or as auxiliarily unit. Although these features are shown in FIG. 1, there may be other types of devices here the display is not disposed near the keyboard. Thus it would best to just describe the features without reference to their location with respect to another feature.

Furthermore, The portable wireless terminal 10 includes a mainboard (not shown) mounted in the inside of the case frame 101, and a built-in antenna electrically connected to the mainboard that is suitable for transmitting/receiving a signal in a relevant frequency band. More particularly, according to an exemplary embodiment of the present invention, the built-in antenna selectively and electrically connects a first antenna radiator to a replaceable second antenna radiator to transmit/receive a signal in an updated resonance frequency band.

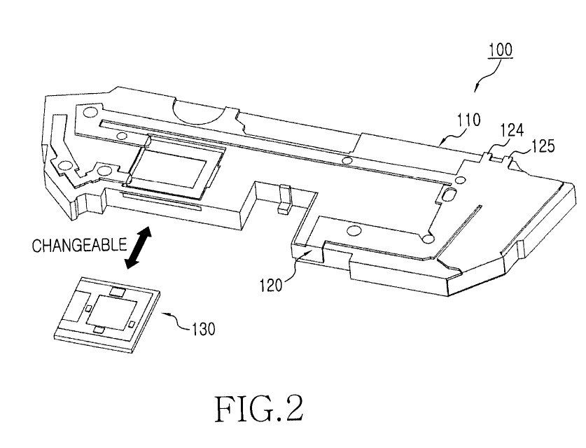

FIG. 2 is a perspective view illustrating a built-in antenna according to an exemplary embodiment of the present invention.

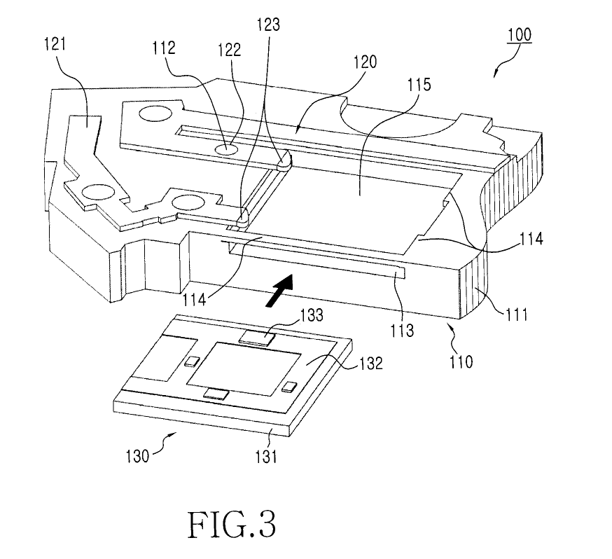

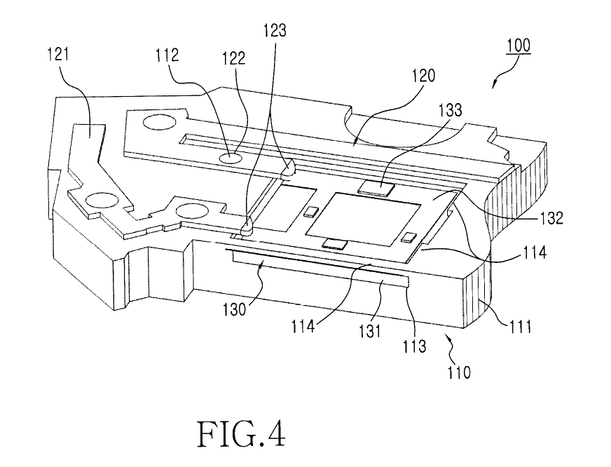

Referring now to FIG. 2, the built-in antenna 100 includes a first antenna radiator 120 having a pattern for radiating a radio signal, and a carrier 110 for fixing the first antenna radiator 120. When the carrier 110 on which the first antenna radiator 120 is fixed is seated on a mainboard (not shown) of a portable wireless terminal, the first antenna radiator 120 is electrically connected to the mainboard. Here, the first antenna radiator 120 includes a feeding pin 124 and a ground pin 125 electrically connected to the mainboard. The feeding pin 124 of the first antenna radiator 120 is electrically connected to the mainboard, so that the built-in antenna 100 receives an electrical signal (e.g., a current) from the mainboard and radiates the same. In addition, the ground pin 125 of the antenna radiator 120 is electrically connected to the mainboard, so that the built-in antenna is grounded. Furthermore, the built-in antenna 100 includes a second antenna radiator 130 that be selectively added to the conductor pattern 121 of the first antenna radiator 120 to change to a new resonance frequency band. The second antenna radiator 130 illustrated in FIG. 2 includes a plate on which a conductor pattern and an antenna matching element are mounted, which is called a matching pad 130 hereinafter. As shown in FIG. 2, when the matching pad 130 is received in a slot formed in the carrier 110, the built-in antenna 100 can transmit/receive a signal in a new resonance frequency band. That is, the built-in antenna 100 can transmit/receive a signal in a resonance frequency band changed by selectively adding the matching pad 130. Detailed description of each element is described with reference to FIGS. 3 and 4.

FIG. 3 is an exploded perspective view illustrating a matching pad separated from a built-in antenna according to an exemplary embodiment of the present invention, and FIG. 4 is an exploded perspective view illustrating a matching pad coupled in a built-in antenna according to an exemplary embodiment of the present invention.

Referring to FIGS. 3 and 4, the built-in antenna 100 includes a carrier 110, a radiator 120, and a matching pad 130.

The carrier 110 includes a body 111, and a seat 115 formed in the body 111, for seating the matching pad 130. The seat 115 includes an insert hole 113 for receiving the matching pad 130. Furthermore, the seat 115 may include a threshold 114 for preventing the matching pad 130 from being detached upward after the matching pad 130 is seated. When received in the seat 115, the matching pad 130 does not protrude to the surface of the carrier 110. Therefore this assists space securing of the built-in antenna.

The antenna radiator 120 includes a conductor pattern 121 manufactured by a sheet metal process. The conductor pattern 121 includes a feeding pin 124 and a ground pin 125 bent from one end of the conductor pattern 121 and electrically connected to a mainboard (not shown). In addition, the antenna radiator 120 includes a tension portion 123 formed by bending the conductor pattern 121 so that the conductor pattern 121 reaches into the seat 115. When the matching pad 130 is received in the seat 115 of the carrier 110, the tension portion(s) 123 is(are) electrically connected to the matching pad 130 by elastically pressing the matching pad 130 downward. Furthermore, the conductor pattern 121 includes a through hole 122 through which a protuberance 112 protruding from the carrier 110 passes. When the protuberance 112 is fused in the through hole 122, the conductor pattern 121 can be fixed to the carrier 110. The fixing method is not limited thereto but the conductor pattern 121 may be fixed to the carrier 110 using a method such as bonding, screw coupling, and the like. Herein, one end of the conductor pattern 121 is fixedly supported by the carrier 110 using the above-described ultrasonic fusing, bonding, screwing coupling, and the like, so that the tension portion(s) 123 has downward elastic supporting force.

The matching pad 130 includes a non-conductive plate 131, and a conductor pattern 132 mounted on the plate 131, and may further include an antenna matching element 133.

FIG. 4 illustrates the insertion of the matching pad 130 into slot 131 and being seated in seat 115. As shown, tension portion(s) 123 are in electrical contact with the conductor pattern 132. In this illustrated case, two tension portions 123 are shown. However, it would be recognized that additional tension portions 123 may be incorporated without altering the scope of the invention.

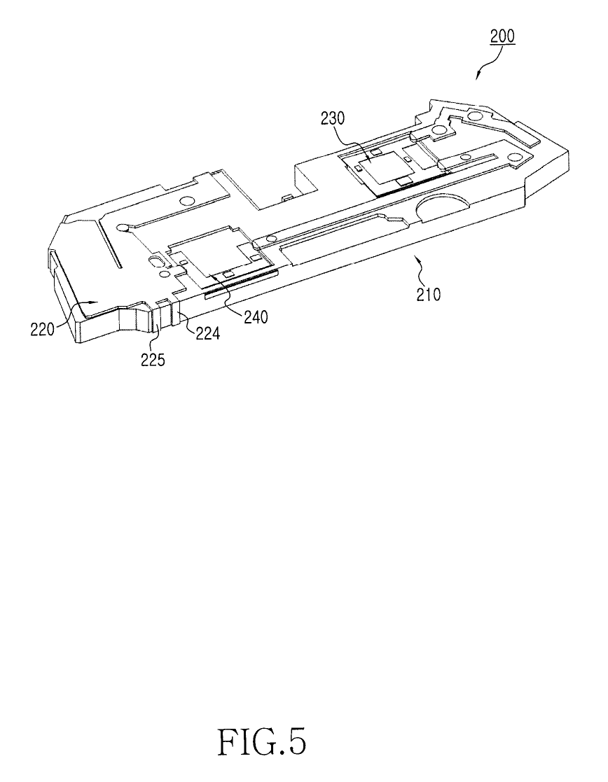

FIG. 5 is a perspective view illustrating a built-in antenna according to another exemplary embodiment of the present invention.

Referring now to FIG. 5, the built-in antenna 200 includes a carrier 210 in which two seats for receiving two matching pads 230 and 240 are formed. Furthermore, the built-in antenna 200 includes a radiator 220 including a tension portion whose one end is fixed to the carrier 210 and whose other end is electrically connected to the matching pads 230 and 240, received in the carrier 210, by pressing the tension portions 123 onto to the matching pads 230, 240. That is, the built-in antenna may be controlled to transmit/receive a signal in a relevant resonance frequency band by selective combination of the replaceable two matching pads 230 and 240 and a radiator 220. A built-in antenna according to an exemplary embodiment of the present invention is not limited to an exemplary embodiment illustrated in FIG. 5 but may be configured to receive three or more matching pads.

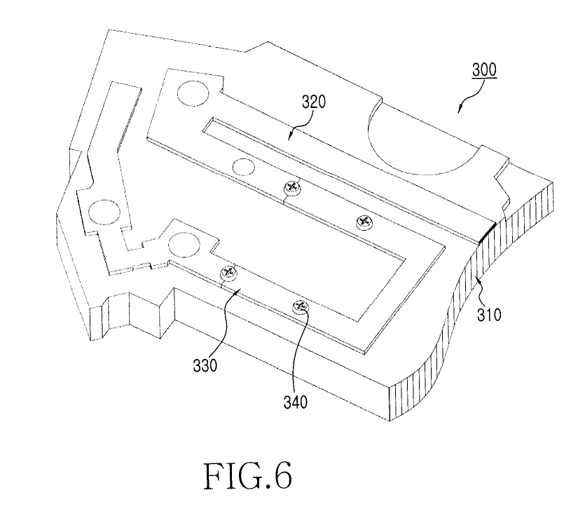

FIG. 6 is a perspective view illustrating a built-in antenna according to another exemplary embodiment of the present invention.

Referring now to FIG. 6, a selectively replaceable second antenna radiator 330 may be mounted on a carrier 310 by using a fastening means such as a screw 340 so that the second antenna radiator 330 is electrically connected to a first antenna radiator 320 already fixed to the carrier 310. At this point, the second antenna radiator 330 is the same thin plate type conductor pattern as the first antenna radiator 320 and can be detachable from the surface of the carrier 310. Here, the carrier 310 does not need to provide the seat described in FIGS. 2 to 5, and a recess corresponding to the screw 340 is formed in the carrier 310.

In the description of FIGS. 2 to 6, in the proposed built-in antennas 100, 200, and 300, the separated first antenna radiators 120, 220, and 320 are electrically connected by the medium of the detachable second antenna radiators 130, 230, 240, and 330.

However, a built-in antenna according to an exemplary embodiment of the present invention is not limited thereto but may include a first antenna radiator having an integral type conductor pattern, and a second antenna radiator that is additionally and electrically connectable to the first antenna radiator. That is, the first antenna radiator having the integral type conductor pattern may independently transmit/receive a signal in a relevant frequency band, and may transmit/receive a signal in a resonance frequency band changed by the additionally coupled second antenna radiator. As would be recognized, the changed resonance frequency band is determined by the configuration of the second antenna.

When a built-in antenna of a portable wireless terminal according to an exemplary embodiment of the present invention is used, a change to a relevant resonance frequency is easy, so that costs for antenna development are reduced, and strategic global launching can be led.

While the invention has been shown and described with reference to certain exemplary embodiments thereof, it will be understood by those skilled in the art that various changes in form and details may be made therein without departing from the spirit and scope of the invention as defined by the appended claims and their equivalents. Therefore, the scope of the present invention is defined not by the detailed description of the invention but by the appended claims, and all differences within the scope will be construed as being included in the present invention.

What is claimed is:

1. A built-in antenna of a portable wireless terminal, comprising:
a first antenna radiator for transmitting/receiving a signal;
a carrier for fixing the first antenna radiator thereon; and
at least one second antenna radiator detachable from the carrier, for being electrically coupled with the first antenna radiator when coupled to the carrier to update a resonance frequency in cooperation with the first antenna radiator.

2. The antenna of claim 1, wherein the second antenna radiator comprises a matching pad comprising a non-conductive plate, and at least one of: a conductor pattern mounted on the plate, and an antenna matching element.

3. The antenna of claim 2, wherein the carrier comprises a seat in which the matching pad is fit.

4. The antenna of claim 3, wherein when coupled to the seat of the carrier, the matching pad does not protrude to an external surface of the carrier.

5. The antenna of claim 4, wherein the first antenna radiator is electrically coupled to the matching pad by allowing one end of the first antenna radiator to press the at least one of a conductor pattern and an antenna matching element of the matching pad using an elastic restoring force.

6. The antenna of claim 1, wherein the second antenna radiator comprises a metal thin plate having a pattern.

7. The antenna of claim 6, wherein the metal thin plate is screw-coupled to the carrier so that it is electrically connected to the first antenna radiator.

8. The antenna of claim 1, wherein the first antenna radiator is separated into at least two parts, which are electrically coupled with each other by the medium of the second antenna radiator.

9. The antenna of claim 1, wherein the first antenna radiator comprises an integral conductor pattern, and the second antenna radiator is electrically coupled to the conductor pattern of the first antenna radiator.

10. The antenna of claim 1, wherein the first antenna radiator comprises a feeding pin whose one end is bent to allow the antenna to receive an electrical signal, and a ground pin for grounding the antenna.

11. A portable wireless terminal comprising a built-in antenna, comprising:
a first antenna radiator for transmitting/receiving a signal;
a carrier for fixing the first antenna radiator thereon; and
at least one second antenna radiator detachable from the carrier, being electrically coupled with the first antenna radiator when coupled to the carrier to update a resonance frequency in cooperation with the first antenna radiator.

12. The terminal of claim 11, wherein the second antenna radiator comprises a matching pad comprising a non-conductive plate, and at least one of a conductor pattern mounted on the plate and an antenna matching element.

13. The terminal of claim 12, wherein the carrier comprises a seat in which the matching pad is fit.

14. The terminal of claim 13, wherein when coupled to the seat of the carrier, the matching pad does not protrude to an external surface of the carrier.

15. The terminal of claim 14, wherein the first antenna radiator is electrically coupled to the matching pad by allowing one end of the first antenna radiator to press the at least one of a conductor pattern and antenna matching element of the matching pad using an elastic restoring force.

16. The terminal of claim 11, wherein the second antenna radiator comprises a metal thin plate having a pattern.

17. The terminal of claim 16, wherein the metal thin plate is screw-coupled to the carrier so that it is electrically coupled to the first antenna radiator.

18. The terminal of claim 11, wherein the first antenna radiator is separated into at least two parts, which are electrically coupled with each other by the medium of the second antenna radiator.

19. The terminal of claim 11, wherein the first antenna radiator comprises an integral conductor pattern, and the second antenna radiator is electrically coupled to the conductor pattern of the first antenna radiator.

20. The terminal of claim 11, wherein the first antenna radiator comprises a feeding pin whose one end is bent to allow the antenna to receive an electrical signal, and a ground pin for grounding the antenna.
